(19) United States
(12) Patent Application Publication
(10) Pub. No.: US 2012/0162198 A1
(43) Pub. Date: Jun. 28, 2012

(54) Information Processor, Information Processing Method, and Computer Program Product

(76) Inventors: Akira Nakanishi, Tokyo (JP); Yusuke Fukai, Tokyo (JP); Armand Simon Alymamy Girier, Tokyo (JP)

(21) Appl. No.: 13/215,886

(22) Filed: Aug. 23, 2011

(30) Foreign Application Priority Data
Dec. 27, 2010 (JP) 2010-290714

(51) Int. Cl. G06T 15/00

(52) U.S. Cl. 345/419

(57) ABSTRACT

According to one embodiment, an information processor is provided with a graphics processing unit (GPU) to display a graphical user interface (GUI) screen on a display module using the GPU. The information processor includes a storage module, a component specifying module, and an instruction converter. The storage module stores node tree information and an association table. The node tree information sets relationship between nodes to be arranged in a virtual three-dimensional (3D) space corresponding to the GUI screen. The relationship includes positional relationship in the virtual 3D space. The association table defines association between each node and a GUI component that constitutes the GUI screen. The component specifying module specifies a GUI component in association with each node referring to the association table. The instruction converter converts the specified GUI component into a GPU drawing instruction referring to the node tree information and outputs the drawing instruction to the GPU.

### CROSS-REFERENCE TO RELATED APPLICATIONS

This application is based upon and claims the benefit of priority from Japanese Patent Application No. 2010-290714, filed Dec. 27, 2010, the entire contents of which are incorporated herein by reference.

### FIELD

Embodiments described herein relate generally to an information processor, an information processing method, and a computer program product.

### BACKGROUND

There have been known digital televisions, set-top boxes, and the like as digital appliances. Such a digital appliance hardly uses a high-performance central processing unit (CPU) in view of manufacturing cost and the like, and usually uses a CPU with low processing capabilities.

Meanwhile, graphical user interface (GUI) application developers, who develop GUI that provides users with a more comfortable operational environment, have proposed various technologies to improve user-friendliness for users to handle an application using GUI. More specifically, the GUI application developers have proposed technologies to improve the operation response and to support intuitive operation by visual effects.

However, it is difficult to achieve a mesmerizing effect with the CPU having low processing capabilities of digital appliances or the like, especially, digital televisions having a large drawing area.

In recent years, with the development of a graphics processing unit (GPU), not only personal computers but also digital appliances having GUI such as digital televisions have been increasingly provided with GPU. The GUI has a complicated instruction system and the display process is specialized. Further, the GUI has no communication function. Thus, it is difficult to construct GUI independently.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a broadcast receiver as an information processor according to a first embodiment;

FIG. 2 is an exemplary functional block diagram of the information processor in the first embodiment;

FIG. 3 is an exemplary diagram for explaining the case of displaying a virtual three-dimensional (3D) space corresponding to a node tree on the display screen of the display module in the first embodiment;

FIG. 4 is an exemplary flowchart of the process of displaying a node on the display screen in the first embodiment;

FIG. 5 is an exemplary flowchart of the process of instructing to draw a graphical user interface (GUI) component in the first embodiment;

FIG. 6 is an exemplary conceptual diagram for explaining user operation using a GUI screen in the first embodiment;

FIG. 7 is an exemplary diagram of a configuration for a high-speed drawing process in the first embodiment;

FIG. 8 is an exemplary diagram for explaining a specific high-speed drawing process in the first embodiment;

FIG. 9 is an exemplary diagram for explaining a buffering process in the high-speed drawing process in the first embodiment;

FIG. 10 is an exemplary diagram for explaining a second embodiment; and

FIG. 11 is an exemplary diagram for explaining the operation of the second embodiment.

### DETAILED DESCRIPTION

In general, according to one embodiment, an information processor is provided with a graphics processing unit (GPU) to display a graphical user interface (GUI) screen on a display module using the GPU. The information processor comprises a storage module, a component specifying module, and an instruction converter. The storage module is configured to store node tree information and an association table. The node tree information sets in advance the relationship between a plurality of nodes to be arranged in a virtual three-dimensional (3D) space corresponding to the GUI screen. The relationship includes positional relationship in the virtual 3D space. The association table defines in advance association between each of the nodes and a GUI component that constitutes the GUI screen. The component specifying module is configured to specify a GUI component in association with each of the nodes referring to the association table. The instruction converter is configured to convert the GUI component specified by the component specifying module into a GPU drawing instruction referring to the node tree information and output the drawing instruction to the GPU.

Exemplary embodiments will be described in detail below with reference to the accompanying drawings.

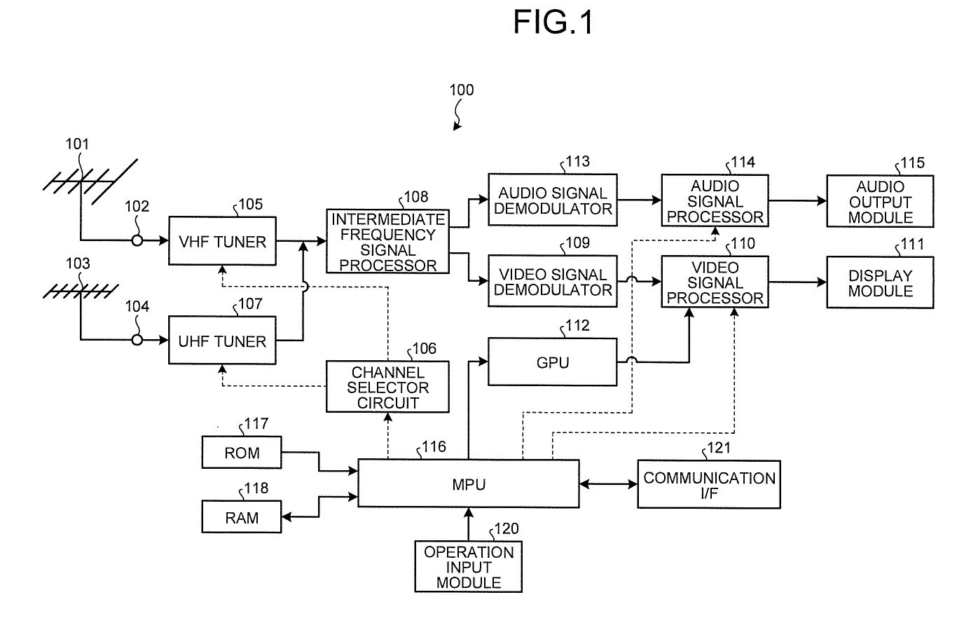

FIG. 1 is a block diagram of a broadcast receiver 100 as an information processor according to a first embodiment.

The broadcast receiver 100 comprises an antenna input terminal 102 and an antenna input terminal 104. An antenna 101 to receive a very high frequency (VHF) broadcast is connected to the antenna input terminal 102, while an antenna 103 to receive a ultra high frequency (UHF) broadcast is connected to the antenna input terminal 104. The antenna 101 is connected to a VHF tuner 105 via the antenna input terminal 102 and, upon receipt of a VHF broadcast signal, outputs it to the VHF tuner 105. The antenna 103 is connected to a UHF tuner 107 via the antenna input terminal 104 and, upon receipt of a UHF broadcast signal, outputs it to the UHF tuner 107.

The VHF tuner 105 and the UHF tuner 107 select a desired channel based on a channel selection signal from a channel selector circuit 106. The VHF tuner 105 and the UHF tuner 107 convert a signal received from the selected channel into an intermediate frequency signal and output it to an intermediate frequency signal processor 108.

The intermediate frequency signal processor 108 amplifies the intermediate frequency signal output from the VHF tuner 105 or the UHF tuner 107, and then outputs it to a video signal demodulator 109 and an audio signal demodulator 113.

The video signal demodulator 109 demodulates the intermediate frequency signal into a baseband composite video signal and outputs it to a video signal processor 110.

In parallel with the above process, a graphics processing unit (GPU) 112 generates a display screen signal in a graphical user interface (GUI) format and outputs it to the video signal processor 110.

The video signal processor 110 adjusts the color, hue, brightness, contrast, and the like of the composite video signal and outputs it to a display module 111 comprising, for example, a liquid crystal display (LCD) and the like to display video. Instead of the composite video signal received from the video signal demodulator 109, the video signal processor 110 may output the display screen signal in the GUI format generated by the GPU 112 or the display screen signal superimposed on the composite video signal to the display module 111 to display video based on the display screen signal in the GUI format.

The audio signal demodulator 113 demodulates the intermediate frequency signal into a baseband audio signal and outputs it to an audio signal processor 114. The audio signal processor 114 adjusts the volume, acoustic quality, and the like of the audio signal and outputs it to an audio output module 115 comprising a speaker, an amplifier, and the like. The audio output module 115 outputs the audio signal as sound.

The broadcast receiver 100 further comprises a microprocessing unit (MPU) 116 that controls the overall operation of the receiver.

Although not illustrated, the MPU 116 comprises, for example, a central processing unit (CPU), an internal read only memory (ROM), and an internal random access memory (RAM).

Connected to the MPU 116 are a ROM 117 that stores a control program to perform various types of processing and a RAM 118 as a work memory that temporarily stores various types of data. The ROM 117 also stores a control program to control the generation of the display screen signal in the GUI format by the GPU 112 as well as data including symbols, letters, and characters to be generated as graphics by the GPU 112. The MPU 116 has a timer function to generate various types of information on time such as current time.

The broadcast receiver 100 further comprises a communication interface (I/F) 121 as an interface to external communication devices such as a remote controller, a router, and the like.

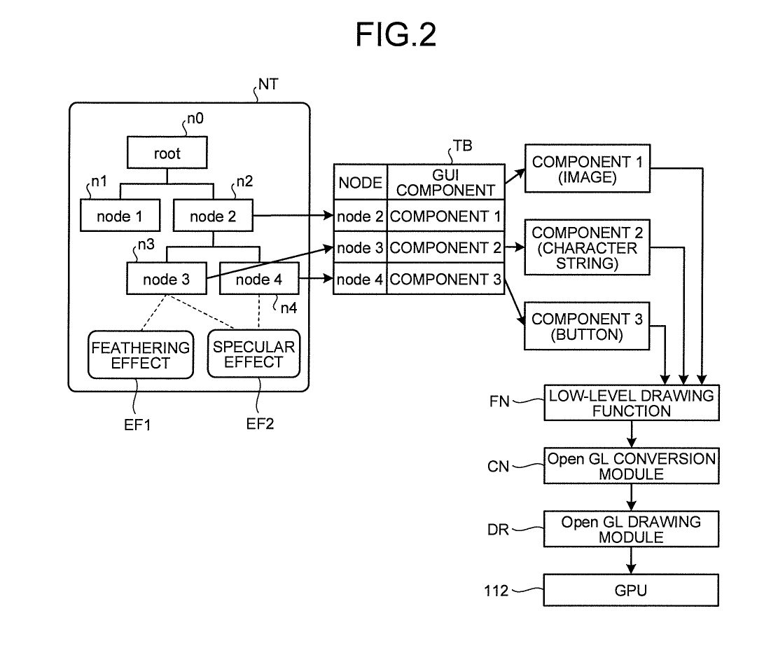

FIG. 2 is a functional block diagram of the information processor according to the first embodiment. The MPU 116 of the broadcast receiver 100 refers to an association table TB and a node tree NT set in advance by an operator, and specifies a node to be displayed on the display module 111 and a corresponding GUI component.

It is assumed herein that each node contains a description of information related to an object to be displayed on the display module 111 as being arranged in a virtual three-dimensional (3D) space. More specifically, each node describes coordinates, rotation, and scaling in a matrix form. By affine transform of the node, an object can be arranged in a virtual 3D space. Accordingly, the node tree NT describes the positional relationship between nodes in the virtual 3D space.

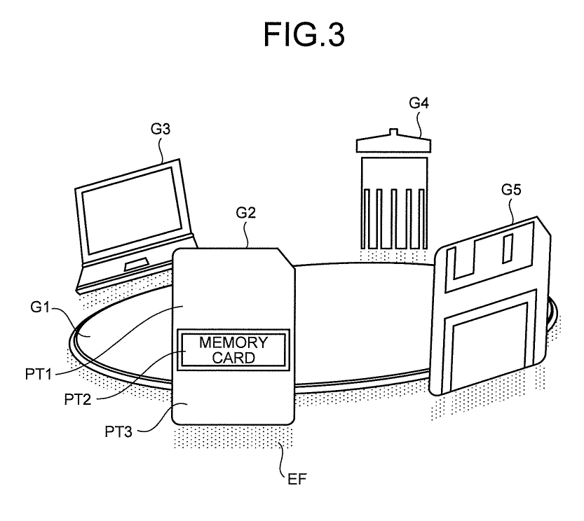

FIG. 3 is a diagram for explaining the case of displaying a virtual 3D space corresponding to a node tree on the display screen of the display module 111.

A circular (oval in terms of 3D display) image G1 is displayed in the center of the display module 111. Displayed around the image G1 are objects such as an icon G2 of a memory card, an icon G3 of a notebook personal computer (PC), an icon G4 of a trash box, and an icon G5 of a flexible disk (FD).

In the following, a description will be given of the relationship between an icon and a node taking the icon G2 as an example. It is herein assumed that, in the node tree NT, the icon G2 is described as a node n2, a node n3, and a node n4. The MPU 116 refers to the association table TB and realizes that the node n2 corresponds to an image component PT1 as a GUI component, a node n3 corresponds to a character string component PT2 as a GUI component, and a node n4 corresponds to a button component PT3 as a GUI component.

The relationship among the nodes n2, n3, and n4 that constitute the node tree NT is the same as the relationship among the corresponding image component PT1, the character string component PT2, and the button component PT3. The character string component PT2 and the button component PT3 are ranked lower than the image component PT1.

The MPU 116 calls a low-level drawing function FN corresponding the image component PT1, the character string component PT2, and the button component PT3. The MPU 116 then functions as an Open GL conversion module CN and converts (substitutes) the low-level drawing function FN to (with) an Open GL drawing instruction.

Subsequently, the MPU 116 functions as an Open GL drawing module DR and outputs the Open GL drawing instruction obtained by converting the low-level drawing function FN to the GPU 112 so that drawing is actually to be performed.

By a series of these processes, as illustrated in FIG. 3, the display module 111 displays a display screen in which a memory card-like shaped object (the image component PT1) corresponding to the nodes n2, n3, and n4 is arranged near the circumference of the image G1.

As described previously, since the character string component PT2 and the button component PT3 are ranked lower than the image component PT1, if, for example, the memory card-like shaped image component PT1 is rotated along the circumference of the image G1, a character string that forms the character string component PT2 is displayed while moving along the rotation of the image component PT1 in such a manner as if the character string is printed on the surface of the image component PT1. Besides, by clicking a position within the display area of the image component PT1 on the display screen, the button component PT3 realizes the function assigned thereto (for example, displaying the contents of the memory card, etc.).

If an effect process is assigned to the image component PT1, the character string component PT2, or the button component PT3, the effect process is performed depending on the display state or the operation state of the component PT1, PT2, or PT3. In the example of FIGS. 2 and 3, specular reflection effect EF (specular effect EF2 in FIG. 2) is set with respect to the background of the image component PT1.

A description will be given of the development of a GUI application. The GUI application developer as an operator constructs the node tree NT and arranges nodes in a virtual 3D space.

In the first embodiment, the GUI application developer is provided with arrangement functions, for example, as follows: a node generation function to generate a node; a root node setting function to set a root node; a child node setting function to set a child node to a node; a parent change function to change a parent node, a node rotation function to rotate a node; a node scaling function to scale up/down the node; a node move function to move a node; and an a value change function to change the transmission of a node.

There is also provided an association function to associate a node with a GUI component. By performing the association function, the MPU 116 automatically generates or updates the association table TB.

More specifically, when the association table TB is updated, a new line is added to the association table TB and a node in a node tree is associated with a GUI component for actual drawing.

The GUI application developer is further provided with animation functions. Example of the animation functions include: a coordinate location object generation function to generate an animation object from a coordinate location; a rotation object generation function to generate an animation object from a rotation angle; a scaling object generation function to generate an animation object from a scaling ratio; and an a value object generation function to generate an animation object where an α value is changed. These animation object generation functions are realized by a transformation matrix, and expected effects are achieved by application of the affine transform.

If a generated animation object is registered in association with a start time and an animation period, the animation can be automatically reproduced. Further, in addition to the animation of a node itself, animation can be provided by moving a camera on the view side with respect to the display screen. Still further, the GUI application developer is provided with visual effect add functions.

Examples of the visual effect add functions include: a black/white effect for black and white display of a node; a feathering effect for feathering display of a node; a blur effect to add a blur caused when a moving object is captured by a camera; a light source effect to arrange a light source to illuminate a node; a specular reflection effect to add specular reflection using a node or the background as a mirror surface; and a contour extraction effect to extract the contour of a node and display it.

These visual effects are realized by using GPU software instruction function. To add any of the visual effects, the GUI application developer specifies the object for a desired visual effect and associates it with a node. Under the control of the MPU 116, the GPU 112 automatically determines the visual effect at the time of drawing the node, and performs drawing base on a corresponding GPU software instruction.

To display the screen as illustrated in FIG. 3 on the display module 111, first, the GUI application developer creates layout information for a desired node using a node operation function. The GUI application developer then generates an instance of a GUI component. After setting attribute values such as an image file path, the GUI application developer associates the instance with each node. By compiling the instance in an executable format and executing it, generation of the GUI screen can be achieved.

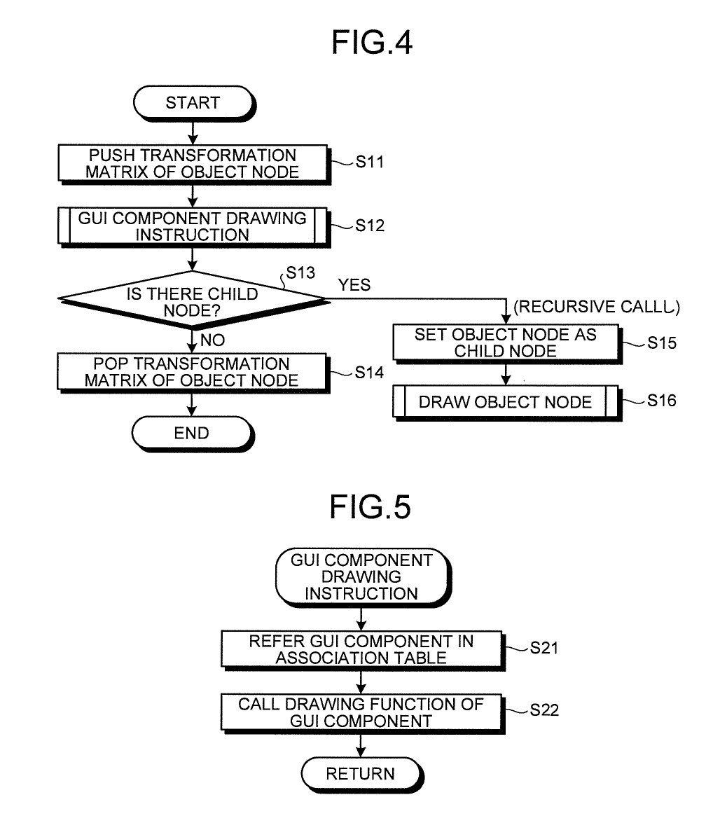

Drawing operation will be described below. FIG. 4 is a flowchart of the process of displaying a node on the display screen. The MPU 116 periodically and automatically performs drawing according to a cycle set in advance by the GUI application developer.

More specifically, at the time of drawing, the MPU 116 refers to the node tree NT, searches for nodes as giving priority to the depth from a root node, and draws the nodes in the search order. Before causing the GPU 112 to perform drawing, the MPU 116 pushes a transformation matrix set to a node to be drawn (hereinafter, “object node”) onto a drawing process stack (S11). Subsequently, the MPU 116 issues a GUI component drawing instruction (S12).

FIG. 5 is a flowchart of the process of the GUI component drawing instruction. First, the MPU 116 refers to the association table TB and realizes the relationship between a node and a GUI component (S21).

Thereafter, with respect to the GUI component to which reference has been made, the MPU 116 calls a corresponding low-level drawing function FN. The MPU 116 then functions as the Open GL conversion module CN and converts the low-level drawing function FN into an Open GL drawing instruction. In other words, the low-level drawing function FN is substituted by an GPU instruction (a drawing instruction) based on the vertex coordinates of the drawing object in a 3D space. The conversion into an Open GL drawing instruction generally means to convert a low-level drawing function (a low-level drawing instruction) such as “to draw a line from coordinates (x1, y1) to coordinates (x2, y2)”, “to fill in a surface represented by a width and a height with coordinates (x, y) as an origin”, or the like into 3D vertex coordinates and a drawing instruction.

In this manner, the low-level drawing function of the GUI component is converted into a GPU instruction described by the vertex coordinates of the 3D space, and thus goes well together with a transformation matrix. Accordingly, by simply applying the affine transform, the GUI component can be drawn in a virtual 3D space.

After that, the MPU 116 calls a low-level drawing function FN corresponding to one or more image components. The MPU 116 then functions as the Open GL conversion module CN and converts the low-level drawing function FN into an Open GL drawing instruction. Subsequently, the MPU 116 functions as the Open GL drawing module DR and outputs the Open GL drawing instruction obtained by converting the low-level drawing function FN to the GPU 112 so that drawing is actually to be performed (S22).

Next, the MPU 116 determines whether there is a child node, i.e., a lower-hierarchy node, of the object node (S13).

If there is no child node of the object node (No at S13), the MPU 116 pops the transformation matrix set to the object node to be drawn off the drawing process stack (S14). Then, the process ends.

On the other hand, if there is a child node of the object node (Yes at S13), the MPU 116 sets the object node as the child node (S15), and issues a GUI component drawing instruction (S16).

With this, if there is a child node, i.e., a lower-hierarchy node, of the object node, drawing is called recursively. Accordingly, if drawn as the object node, the child node takes over the transformation matrix of the parent node. After the drawing of the child node, the object node as a parent node pushes the transformation matrix thereof onto the drawing process stack and restarts the drawing process.

More specifically, if the parent node has a rotation transformation matrix, the rotation transformation matrix is automatically applied to the child node.

As described above, the drawing process of the object node is configured to allow recursive call. Thus, the GUI application developer is not required to control transformation matrices one by one. By only constructing an appropriate node tree, the layout, animation, and visual effects can be applied to each node.

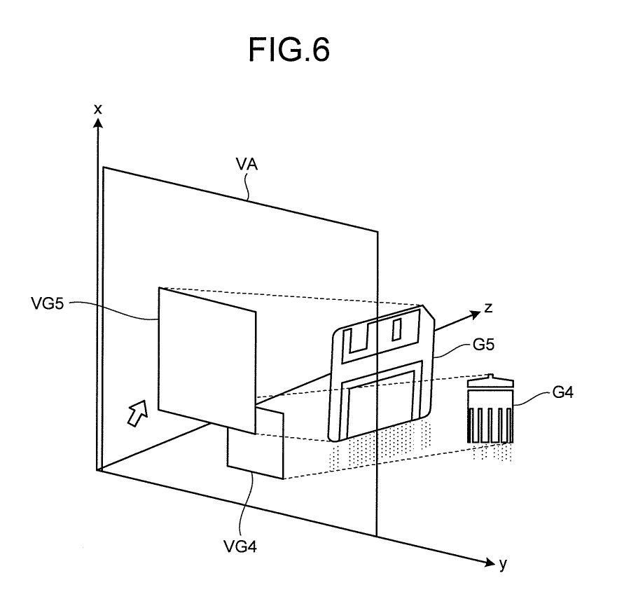

FIG. 6 is a conceptual diagram for explaining user operation using a GUI screen. In the GUI screen, the projection area of a GUI component is present in a projection plane VA of a virtual 3D space on the display screen of the display module 111.

For example, FIG. 6 illustrates a projection area VG4 corresponding to a trash box icon G4 and a projection area VG5 corresponding to a flexible disk icon G5. In the projection areas VG4 and VG5, an arrow-shaped pointer is displayed. An operation input module 120 determines whether a predetermined click action is made. If the click action is made in a projection area, the operation input module 120 notifies a corresponding GUI component of the event.

Specifically, if a predetermined operation button of the operation input module 120 is clicked while the pointer is present in the projection area VG5, a device and a function (for example, function of displaying the contents of a memory device) assigned in advance to the flexible disk icon G5 are implemented.

More specifically, if a predetermined click action is made in the operation input module 120 while the pointer is located at the position of coordinates (x, y), a candidate node is detected that has a projection area containing the coordinates (x, y) in the projection plane VA. That is, in the display state of the display screen of the display module 111 at the timing, the position of the projection area of an icon corresponding to each node is calculated. Then, it is determined whether the projection area contains the coordinates (x, y). If the projection area contains the coordinates (x, y), the distance in the depth direction (z axis direction in FIG. 6) is stored.

The MPU 116 repeats the same process for all nodes and determines a candidate node with the shortest distance in the depth direction from the display screen among candidate nodes having a projection area containing the coordinates (x, y) in the projection plane VA. The MPU 116 transfers the click event to a GUI component corresponding to the candidate node determined. Generally, the GUI component provided by a GUI tool kit has the function of receiving an event, and this function is used for the implementation.

With this, arrangement in a virtual 3D space, animation, visual effect addition, and the like can be realized without affecting GUI communication function. Accordingly, the GUI application developer can describe click input operation using a GUI component for an existing 2D drawing area. This ensures the efficiency of GUI development

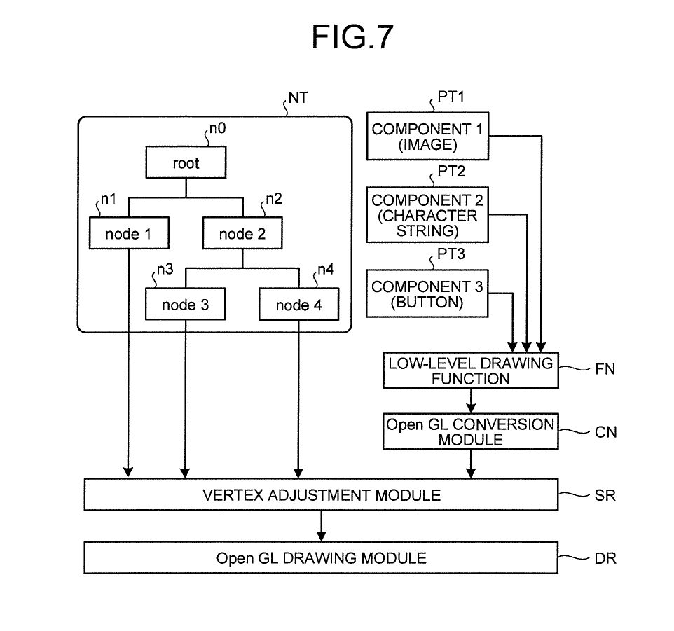

In the following, speeding up of drawing process will be described. FIG. 7 is a diagram of a configuration for a high-speed drawing process. In general, if graphics are drawn using GPU, it is desirable to reduce the drawing instructions as much as possible. Besides, the Open GL is a state machine and the state change generally imposes a heavy load, which affects the drawing speed.

In the foregoing, the drawing order is described as being determined according to an algorithm giving priority to the depth with respect to the constructed node tree NT; however, the effect of state change is not mentioned.

In the first embodiment, to prevent a drop in drawing speed due to state change, as illustrated in FIG. 7, a vertex adjustment module SR is located between the Open GL conversion module CN and the Open GL drawing module DR. The vertex adjustment module SR buffers a transformation matrix from a node, an Open GL drawing instruction, and vertex data corresponding to a GUI component and adjusts them.

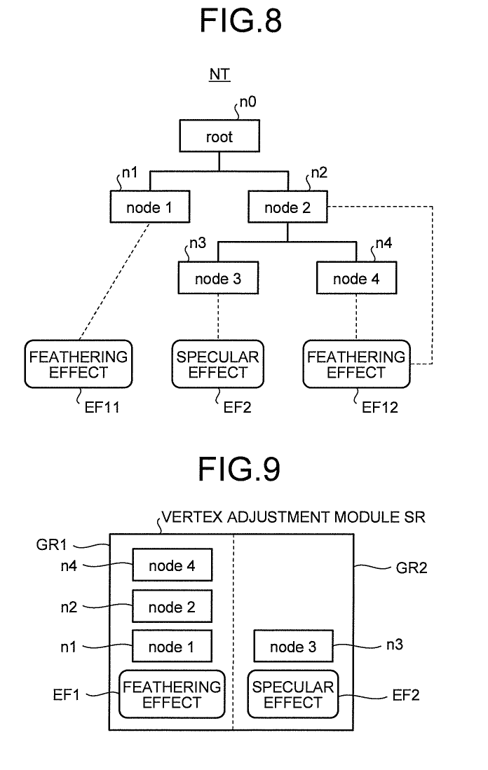

FIG. 8 is a diagram for explaining a specific drawing process. The node tree NT includes, below a root node, the nodes n1 and n2 and, below the node n2, the nodes n3 and n4.

It is herein assumed that feathering effects EF11 and EF12 are applied to the nodes n1, n2, and n4, while specular effect EF2 is applied to only the node n3 differently from other nodes. In this case, the general drawing order, i.e., “the node n1 (feathering effect)”→“the node n2 (feathering effect)”→“the node n3 (specular effect)”→“the node n4 (feathering effect)”, requires four drawing processes (three state changes).

FIG. 9 is a diagram for explaining a buffering process in the high-speed drawing process. In this regard, according to the first embodiment, the vertex adjustment module SR buffers nodes to which the same effect is applied in the same buffer area as illustrated in FIG. 9.

More specifically, the vertex adjustment module SR buffers the nodes n1, n2, and n4 to which are applied the feathering effects EF11 and EF12 (the feathering effect EF1) in a buffer area GR1. Meanwhile, the vertex adjustment module SR buffers the node n3 to which is applied the specular effect EF2 in a buffer area GR2.

Upon completion of buffering of all nodes, the MPU 116 functioning as the vertex adjustment module SR combines vertex data of the nodes stored in each of the buffer areas GR1 and GR2, and executes a single Open GL drawing instruction.

Accordingly, in the first embodiment, the drawing order, i.e. , “the nodes n1, n2, and n4 (the feathering effect EF1)”→“the node n3 (specular effect)”, requires two drawing processes (one state change). Compared to the general drawing as described above, the drawing processes reduce to a half, and the state changes reduce to one third. This substantially improves processing speed.

While an example is described above in which two buffer areas are used, if there is a node to which is applied a different effect during buffering, the node is buffered in a different buffer area (or a different buffer). A drawing instruction is issued with respect to each buffer area (or each buffer).

Besides, if a node itself is a parent node, it is not allowed to change the drawing order in which a parent node is drawn before a child node. Accordingly, effect applied to the child node is checked. If the effect has already been buffered, actual drawing starts at the point, all buffer areas (or all buffers) are flushed (cleared), and buffering is newly started. On the other hand, if yet to be buffered, the effect is buffered in a different buffer area (or a different buffer).

The process procedure (algorithm) can be applied to state change. For example, in the Open GL drawing instruction system, there is provided a state where alpha blending is enabled, a depth buffer is used, or a stencil buffer is used as the state. Accordingly, in this case also, buffering is performed in the drawing order giving priority to the depth as in the case of effect. If there is a different state than a current state, the state is buffered in a different buffer area (or a different buffer), and actual drawing starts at the point in the same manner as described above.

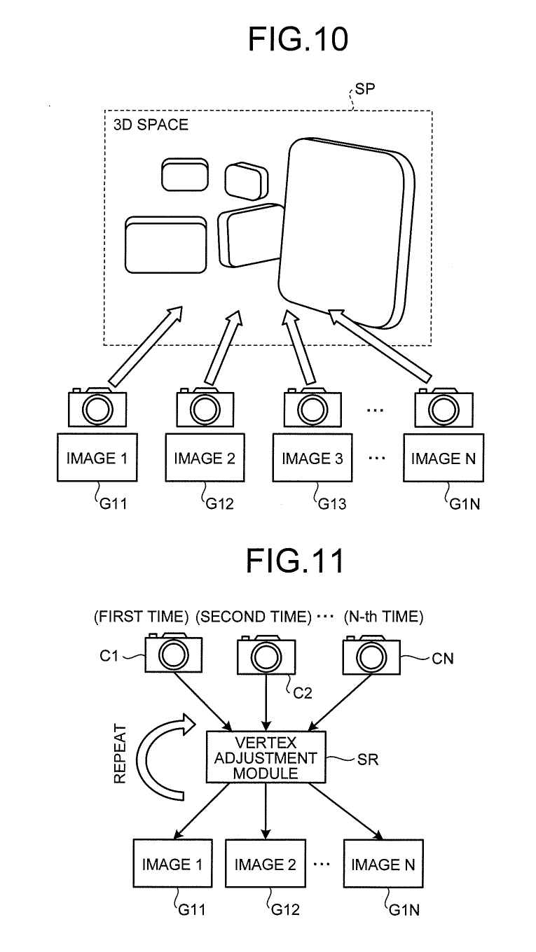

FIG. 10 is a diagram for explaining a second embodiment. In the second embodiment, GUI is realized in a 3D digital television (TV). In the second embodiment, with respect to GUI arranged in a virtual 3D space SP, images G11 to G1N are redrawn while a camera is moved among positions C1 to CN. Thus, a GUI screen is easily generated for each disparity.

FIG. 11 is a diagram for explaining the operation of the second embodiment. In this case also, as previously described in connection with FIGS. 7 to 9, when the same effect or the same state change is assigned to a plurality of nodes, the vertex adjustment module SR performs buffering as illustrated in FIG. 11. More specifically, the MPU 116 functioning as the vertex adjustment module SR buffers the vertex data. With this, even if a screen image is drawn N times for each disparity, the time required for the drawing or required drawing speed are not simply increased N times. Thus, processing speed can be increased. This is especially effective to realize the 3D visualization of GUI upon viewing the large screen of a glasses-free 3D TV.

While the above embodiments are described as being applied to an information processor compatible with an Open GL instruction system as GPU instruction system, they may also be applied to an information processor compatible with other GPU instruction systems such as DirectX. Further, the above embodiments maybe similarly applied to an emulation environment by CPU provided with no GPU.

The information processor of an embodiment has a hardware configuration of a general computer and comprises a controller such as CPU, a storage device such as ROM and RAM, an external storage device such as a hard disk drive (HDD) and a compact disc (CD) drive, a display device such as LCD, and an input device such as a keyboard and a mouse.

The control program executed on the information processor of an embodiment may be provided as being stored in a computer-readable storage medium, such as a compact disc-read only memory (CD-ROM), a flexible disk (FD), a compact disc recordable (CD-R), and a digital versatile disc (DVD), as a file in an installable or executable format.

The control program may also be stored in a computer connected via a network such as the Internet so that it can be downloaded therefrom via the network. Further, the control program may be provided or distributed via a network such as the Internet.

The control program may also be provided as being stored in advance in ROM or the like.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor provided with a graphics processing unit (GPU) to display a graphical user interface (GUI) screen on a display module using the GPU, the information processor comprising:
a storage module configured to store node tree information that sets in advance relationship between a plurality of nodes to be arranged in a virtual three-dimensional (3D) space corresponding to the GUI screen, the relationship including positional relationship in the virtual 3D space, and an association table that defines in advance association between each of the nodes and a GUI component that constitutes the GUI screen;
a component specifying module configured to specify a GUI component in association with each of the nodes referring to the association table; and
an instruction converter configured to convert the GUI component specified by the component specifying module into a GPU drawing instruction referring to the node tree information and output the drawing instruction to the GPU.

2. The information processor of claim 1, wherein
the GUI component comprises a low-level drawing function, and
the instruction converter comprises an instruction substitute module configured to substitute the low-level drawing function with the GPU drawing instruction.

3. The information processor of claim 2, further comprising an instruction adjustment module configured to buffer a plurality of drawing instructions substituted by the instruction substitute module according to a plurality of predetermined classifications, and combine a plurality of drawing instructions buffered with respect to each of the classifications.

4. The information processor of claim 3, wherein the classifications may be effects to be applied to the nodes or state change.

5. An information processing method applied to an information processor provided with a graphics processing unit (GPU) to display a graphical user interface (GUI) screen on a display module using the GPU,
the information processor comprising a storage module configured to store node tree information that sets in advance relationship between a plurality of nodes to be arranged in a virtual three-dimensional (3D) space corresponding to the GUI screen, the relationship including positional relationship in the virtual 3D space, and an association table that defines in advance association between each of the nodes and a GUI component that constitutes the GUI screen,
the information processing method comprising:
specifying a GUI component in association with each of the nodes referring to the association table; and
converting the GUI component specified at the specifying into a GPU drawing instruction referring to the node tree information and outputting the drawing instruction to the GPU.

6. A computer program product applied to an information processor provided with a graphics processing unit (GPU) to display a graphical user interface (GUI) screen on a display module using the GPU,
the information processor comprising a storage module configured to store node tree information that sets in advance relationship between a plurality of nodes to be arranged in a virtual three-dimensional (3D) space corresponding to the GUI screen, the relationship including positional relationship in the virtual 3D space, and an association table that defines in advance association between each of the nodes and a GUI component that constitutes the GUI screen,
the computer program product embodied on a non-transitory computer-readable storage medium and comprising code that, when executed, causes a computer to perform:
specifying a GUI component in association with each of the nodes referring to the association table; and
converting the GUI component specified at the specifying into a GPU drawing instruction referring to the node tree information and outputting the drawing instruction to the GPU.
